(19) United States
(12) Patent Application Publication
(10) Pub. No.: US 2023/0245509 A1
(43) Pub. Date: Aug. 3, 2023

(54) Safety system and method for motor vehicles

(71) Applicants: Murray Armstrong, Austin, TX (US); Harriet Chen, Ann Arbor, MI (US)

(72) Inventors: Murray Armstrong, Austin, TX (US); Harriet Chen, Ann Arbor, MI (US)

(21) Appl. No.: 17/803,063

(22) Filed: Jan. 28, 2022

(51) Int. Cl. G07C 5/08; G06F 16/11; G01C 21/00; G07C 5/02

(52) U.S. Cl. CPC G07C 5/0808; G06F 16/11; G01C 21/3822; G07C 5/02

(57) ABSTRACT

A safety system characterized in that centralized information indicative of safe vehicle performance expectations along a roadway in consideration of the predicted weather is transmitted to a given vehicle and wherein said given vehicle may have an on-board safety unit for adjusting the vehicle operation to reflect deviations in the performance of the given vehicle relative to said safe vehicle performance expectations.

### RELATED APPLICATIONS

This application is related to previously filed and copending U.S. Provisional Patent Application 206,145, filed Jan. 30, 2021, for “Safety System and Method for Motor Vehicles”, the entirety of which is hereby incorporated by reference.

### FIELD OF THE INVENTION

The present invention relates to automotive safety systems and methods and to systems and methods related to improving control of vehicles while traversing roadways that may have varying surface conditions. On board and remote data systems can generate and distribute information related to actual and predicted roadway conditions and can include information related to actual weather conditions, predicted weather conditions, actual vehicle traction data from other vehicles and predicted vehicle traction. The remote data systems can provide generalized predictive roadway information representative of typical vehicle characteristics. The specific vehicle can tailor the generalized information based on information contained on board, to more accurately predict vehicle performance on the roadway. The on board systems can provide feedback to the remote systems to further improve available information for other vehicles traversing the same roadway. Predicted vehicle performance information can be used to regulate vehicle speed to avoid experiencing unsafe operating conditions.

### BACKGROUND

An example of the previous approaches mentioned above can be found in U.S. Pat. No. 9,903,728 entitled “Systems and Methods for Predicting Weather Performance for a Vehicle”, issued Feb. 27, 2018. This patent is directed to a system that includes sensors and sensor systems, and methods for analyzing data from these sensors, in order to measure characteristics of the tire/road interface in varying environmental conditions, as well as to provide information, guidance, and predictions to drivers, fleet managers, traffic managers, safety services, navigation and/or self-driving vehicle systems, models, services and other interested parties that use weather information and predictions. The following excerpts from that patent demonstrate the system and method of predicting road conditions based on historical road conditions.

“In one aspect of the presented inventions, sensor data is used to compute coefficients of friction and slip ratios for the vehicle in certain situations. For example, the wheel rotational acceleration and/or velocity are compared with the linear vehicle acceleration and/or velocity and the difference between the two are computed in order to provide an estimate of coefficient of friction and/or slip ratio. Multiple such measurements may be utilized to generate curves, equations and/or tables of coefficient of friction vs. slip ratios. Likewise, such curves, equations and/or tables may be generated for differing environmental and/or road conditions. In another example, the change in velocity and/or acceleration of a vehicle is calculated during a braking situation in order to provide an estimate of coefficient of friction. In some embodiments, this rate of change is measured by using GPS to identify the known distance over which braking has occurred, and measurement of the total time of braking in order to establish the time over which braking has occurred. In some embodiments, the wheel rotational orientation and vehicle speed along a road with a known geometry is measured in order to estimate the weight of the vehicle. In some embodiments, sensors such as radar, lidar, sonar, or (e.g. 3D) computer vision are used to measure/estimate the distance to other objects, which can be combined with stopping distance information to provide safety information. In some embodiment, computer vision is used to determine visibility, weather conditions (e.g. sleet hail, or black ice), road conditions (e.g. potholes and buckling) and roadside hazards and issues (e.g. semi-tractor trailer tires that have been shed, dead animal etc.). In other embodiments, the tire pressure is measured in order to estimate the vehicle's tire radius and/or contact surface with the ground.

In another aspect of the presented inventions, profiles of coefficients of frictions and slip ratio and plots of coefficient of friction (COF) versus slip ratio for a vehicle are compiled over time, across a variety of road environments. In one embodiment, these profiles are tagged with information about geographic position and/or are tagged with information about time. In one embodiment, these profiles are tagged with information about environmental conditions. Such environmental conditions may be identified from information provided from the National Weather Service or National Center for Atmospheric Research's (NCAR's) Pikalert system, Road Weather Information System (RWIS), Meteorological Terminal Aviation Routine Weather Report (METAR) or Terminal Aerodrome Forecast (TAF), UCAR's Location Data Manager (LDM) Etc. In another embodiment, the environment conditions are derived, at least in part, by sensor(s) on or near a vehicle at the time the measurements relating to coefficient of friction and slip ratio are taken. In one embodiment, local precipitation is measured using a precipitation gauge mounted on the vehicle, for example on the front windshield. In such an embodiment, the type of precipitation (e.g., rain, snow) is measured directly by the precipitation sensor or inferred from a combination of sensor measurements. In one embodiment, local road temperature and conditions are monitored by an infrared camera mounted to the vehicle, for example on the vehicle bumper. Likewise, light or camera sensors may be used to detect/measure cloud cover. Further, motion sensors may be used to detect/measure wind velocity and gusts.

In still another aspect of the presented inventions, the COF or COF vs slip ratio curve for a vehicle are predicted for future environmental conditions and/or future road conditions based on the past COF performance of the vehicle. In one embodiment, the future environmental condition is chosen based on a vehicle's expected travel path. In one embodiment, the future environmental condition represents the present environmental condition at a location that the vehicle will soon be in. In one embodiment, the future environmental condition includes a prediction of the environmental state of that location based on a combination of the present environmental condition and a model that predicts environmental changes. In one embodiment, the future environmental condition is derived at least in part from a report from the National Weather Service. In one embodiment, the future environmental condition is derived at least in part from environmental data taken at that location by fixed sensors. In one embodiment, the future environmental condition is derived at least in part from environmental data taken at that location by mobile sensors. In one embodiment the mobile sensors are affixed to other vehicles. In another embodiment, future road conditions are derived at least in part from road condition information taken by mobile sensors. In one particular embodiment, future or upcoming coefficient of friction information and/or environmental information for a travel path of a vehicle are provided to the vehicle. This upcoming road surface information may be utilized with stored profile information of the vehicle to determine vehicle specific safety information and/or to generate warning outputs.

In yet another aspect of the invention, the future COF is obtained by matching the previously measured COF values and/or curves with environments that resemble the future environment and selecting COF values that most closely match that environment. In one embodiment, the future COF is obtained by first building a model for COF as a function of environmental conditions for a particular vehicle, and then extrapolating from this model to predict the COF for these future environmental conditions. In one embodiment of the invention, data from one or more sensors, vehicles, etc., is stored in a computer database. In another embodiment, models are constructed using Big Data (data analytics/predictive analytics) methods and/or control theory methods such as system identification.

In further aspects of the invention, COF and COF versus slip ratio data for a plurality of vehicles are compiled to form a library of COF data. In one embodiment, data from more than one vehicle in this library is combined to form at least one element of an assessment of road conditions in a specific location common to these vehicles. In one embodiment, the future COF of a first vehicle is predicted based on a mathematical model which comprises data from vehicles other than this first vehicle.”

Another approach for predicting the condition of a roadway segment is disclosed in U.S. Pat. No. 10,319,229, entitled “Data Mining for Alerts Regarding Road Conditions”, issued Jun. 11, 2019. This patent discloses the use of on-line resources, such as weather reports, to predict the condition of a road segment. The following excerpts from the patent show certain methods and systems for forecasting hazardous road conditions. The method includes determining a plurality of sections of road to analyze. The method further includes correlating the sections of roads to localized weather forecasts. The method also includes performing a road surface condition analysis for each section of road of the plurality of sections of road. Based on a prediction of a hazardous road condition, generating an alert regarding the hazardous road condition.

“Embodiments of the present invention are further directed to a computer system for forecasting hazardous road conditions. The system includes a memory and a processor system communicatively coupled to the memory. The processor is configured to perform a method that includes determining a plurality of sections of road to analyze. The method also includes correlating the sections of roads to localized weather forecasts. The method further includes performing a road surface condition analysis for each section of road of the plurality of sections of road. Based on a prediction of a hazardous road condition, generating an alert regarding the hazardous road condition.”

Additional background information is contained in U.S. Pat. No. 10,018,472 entitled “System and Method to Determine Traction of Discreet Locations of a of Road Segment”, patented on Jul. 10, 2018. This patent discloses a traction determination system for use with autonomous vehicles. Among other aspects, vehicles equipped with resources for detecting a traction value of a road surface may transmit traction information to a network service. The vehicle may perform a variety of operations upon determining a traction value of a road surface. For example, the vehicle can plan a trajectory based on detecting a low traction region in front of the vehicle. Alternatively, the vehicle may transmit the traction information to a network service, which may provide a traction map for multiple vehicles operating in a common geographic region.

“In some examples, autonomous vehicles may operate within a geographic region (e.g., city). When events occur (e.g., onset of inclement weather) which may change the traction on the roadway, the vehicles may collectively combine with a network service to create a traction map that identifies a traction value of a road segment. The vehicles may continuously update the traction map during the inclement weather period.

In other aspects, a network service may receive and process traction information for locations of a road network from multiple vehicles. The network service may instruct vehicles on various aspects of vehicle operation based on the traction determination of the locations of the road network.

In some examples, a vehicle is operable to determine a traction value for a surface of a road segment and associates the traction value with a location of the surface. The vehicle stores the traction value and location as part of a traction map.

Still further, in other examples, a computer system operates to determine a traction value for each of a plurality of regions of a road network. The computer system identifies a region of the road network for which the traction value is known. The computer system may direct a vehicle to operate over a region of the road network where the traction value is known, in order to obtain sensor data that is indicative of a traction capability of the vehicle.”

The patent goes on to describe a Map System that may operate to determine and maintain traction information about a road segment on which the vehicle travels. As described with various examples, the traction information can be utilized in connection with performing vehicle operations, such as propulsion, braking and steering. Additionally, in some variations, the vehicle may determine and communicate traction information to a remote source, such as a network service or another vehicle.

In one implementation, the sensor interfaces can receive sensor data to directly measure traction values of the road segment as the vehicle traverses the location of measurement. By way of example, sensors which can make direct measurements that are correlative to traction values at a given location can include tire sensors, which measure the amount of grip which the tires place on the roadway, as well as antilock brake system (“ABS”) sensors, drive train sensors and/or wheel sensors which can detect wheel slip.

### SUMMARY OF THE INVENTION

The present invention relates to systems and methods for to improving control of vehicles while traversing roadways that may have varying surface conditions. On board and remote data systems can generate and distribute information related to actual and predicted roadway conditions. These systems can include information related to actual weather conditions, predicted weather conditions, actual vehicle traction data from other vehicles and predicted vehicle traction. The remote data systems can provide generalized predictive roadway information representative of typical vehicle characteristics. A specific vehicle can tailor the generalized information based on information contained on board the specific vehicle, to more accurately predict vehicle performance on the roadway. The on board systems can provide feedback to the remote systems to further improve available information for other vehicles that will be traversing the same roadway.

More particularly, one aspect of the invention relates to the monitoring of road conditions for the purpose of assessing traction conditions. By monitoring the conditions of the roadway along a route to be traveled by a motor vehicle it is possible to anticipate the presence of slick spots on the road and to take precautionary steps to avoid accidents. The monitoring of the roadway is accomplished through a combination of on-board systems and remote resources. The on-board systems include multiple sensors capable of detecting tire slippage, including sensors associated with anti-skid braking systems and traction control systems. Additional sensors for sensing the sound of the tires as they roll along the pavement are also employed to supplement the other systems already present on the vehicle. Addition vehicle systems can be employed to further refine the information indicative of roadway conditions, including wiper systems and heating systems. Then wipers are operating, it might be concluded that there is precipitation. When heaters are operating, it might be concluded that temperatures are cool, but also that there is significant humidity, particularly when a defroster is being used. On board outside temperature sensors are also reliable sources of incremental information aiding in prediction of roadway conditions. Still further, a specific roadway temperature sensor might be employed.

Additional information is available from broadcast weather reports in the vicinity of the planned route along with a history database of previous weather reports. The weather data can be correlated with actual road conditions previously reported along the planned travel path to build a record of actual road conditions as a function of the forecasted weather. The correlated historical data is employed to predict actual road conditions based on the current weather forecast. In one embodiment, prior weather forecasts are compared to actual prior weather to identify any consistent deviations in actual weather relative to predicted weather. This type of deviation is most common in areas where local terrain causes a local weather anomaly, such as cold air pooling in a valley, or fog frequently appearing along an upslope. Having access to previous micro-weather situations can be advantageously employed for prediction of road conditions in these discrete locations along the roadway.This information can be employed either on board or at a central location to provide information related to predicted traction conditions along a particular section of the roadway additionally similar predictive information can be available for each section of the roadway thereby providing predicted roadway conditions along substantially the entire route to be traveled.

The traction capabilities of various motor vehicles along any particular type of roadway are not absolutely identical and thus the predicted road conditions will be useful in predicting an average coefficient of friction along the roadway for a range of vehicles. Further this information can predict which segments of the roadway will be the most slippery.

An aspect of the present invention expands on these prior capabilities by adding additional information about the specific performance of a particular driven or subject vehicle relative to an average of other vehicles (not necessarily an average of all vehicles, but of a representative subset or sample) for the purpose of more precisely determining whether the driven vehicle will be able to safely navigate the planned travel path.

This aspect of the present invention builds on the prior technology by recognizing that individual (subject or target) vehicles deviate from averages. According to the present invention vehicle traction performance for a specific vehicle is determined and is compared to a database of traction performance of a number of other vehicles for the purpose of assessing the deviations in traction performance of the specific vehicle from the average performance of the other vehicles. It is an object of the present invention to provide an incremental improvement in vehicle safety by providing an additional degree of refinement to the pre-existing approaches for safeguarding a specific, subject or target vehicle traveling a known roadway segment, as opposed to a vehicle in general.

The additional degree of safety comes from building a database of traction performance characteristics of a significant number of motor vehicles as they travel a given roadway segment and calculating an average, cumulative or baseline traction result. This average or baseline is compared to measured performance of the specific vehicle being operated and a more specific deviation for the subject or target vehicle is determined and stored in the specific, subject vehicle. Then, as the vehicle travels any other roadway segment where traction information (based on averages) is available through an external safety system, such as a navigation system with roadway data, the on-board system can apply the previously determined deviation thereby yielding a more accurate indication of the expected traction capabilities of the specific or subject vehicle at the roadway segment being encountered.

This will also be effective for predicting traction performance along the planned travel route of the specific vehicle. Again, when a mapping system or navigation system provides information related to the potential for low traction conditions along any roadway segment, this information is based on accumulated information from other vehicles that have traveled the same road segment. For purposes of this description, information based on analysis of a number of prior vehicles passing a roadway segment is considered to be based on some form of mathematical modeling to result at an indication suitable for use by multiple vehicles that plan to travel that route. Information of this sort is deemed, for purposes of this application, to be a form of average, even if it is not specifically any of a mean, mode or median. The intent here is that the single indicated safety information is indicative of a traction value resulting from consideration of a plurality of different vehicles. Thus, this aspect of the present invention starts with the indicated traction value and applies a calculated deviation specific to the subject or target vehicle, a correction factor to reflect the deviation of the specific vehicle from the value indicated from the generalized plurality of other vehicles.

### BRIEF DESCRIPTION OF THE FIGURES

FIG. 1 illustrates functional elements useful in the implementation of the invention.

FIG. 2 illustrates a representative subset of data communication subsystems that can be employed is various implementations of the invention.

### DETAILED DESCRIPTION OF THE PREFERRED EMBODIMENTS OF THE INVENTION

It has been determined that road condition information can be generated by monitoring a number of vehicles traveling along a given road segment for the purpose of characterizing that road segment for the benefit of future vehicles traveling the same road segment. Each of the three patents mentioned in the background of the invention herein disclose some manner of characterizing a section of a roadway for the purpose of improving safety for others. Further, in each case, the approach to characterizing the road segment involves having a number of vehicles drive along the road segment and having each monitor the road surface through the use of on-board systems such as antiskid braking and traction control systems. The detected information is then delivered to a central location where the collected information from the numerous vehicles is somehow combined for the purpose of generating a composite indication of the driving condition of the roadway.

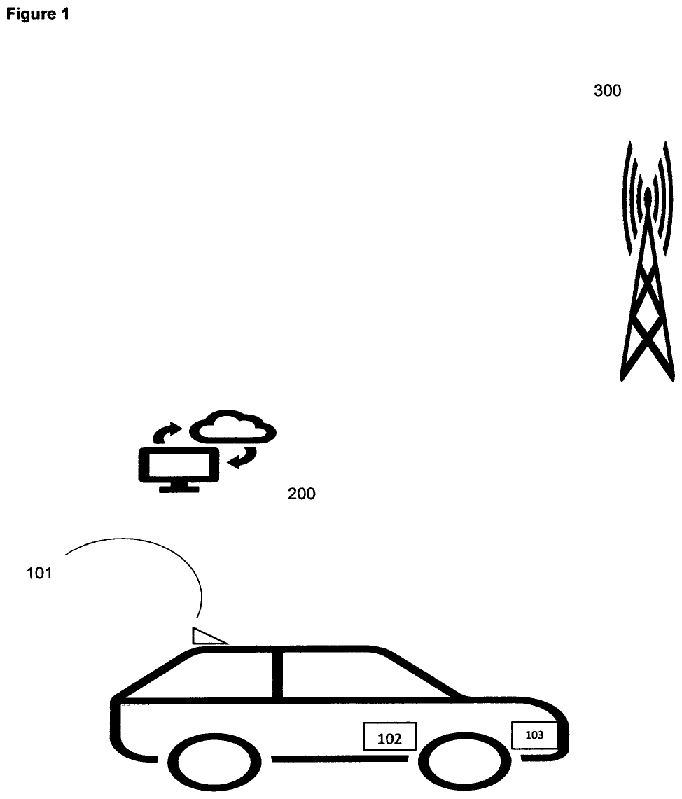

For example, information from the commercially available “LiveRoad” cloud, (illustrated in FIG. 1 as cloud computing system 200 that might also include edge computing functionality—not shown) encompassing atmospheric modeling and other road weather modeling can be input, and an edge computing program can be run to further refine that data sensed from either a sensor of the type provided by LiveRoad or individual, subject vehicle sensors. (“Subject vehicle” is used herein to refer to the individual vehicle that is taking advantage of the features of the invention. This is to be distinguished from the “baseline vehicle” that is a hypothetical vehicle based on average vehicle performance.) Any risks or alerts identified in that process can be sent back to the basic remote platform, for instance the LiveRoad platform, to become incorporated as part of the application programing interface (API) and can then be sent out to all vehicles, including a subject vehicle.

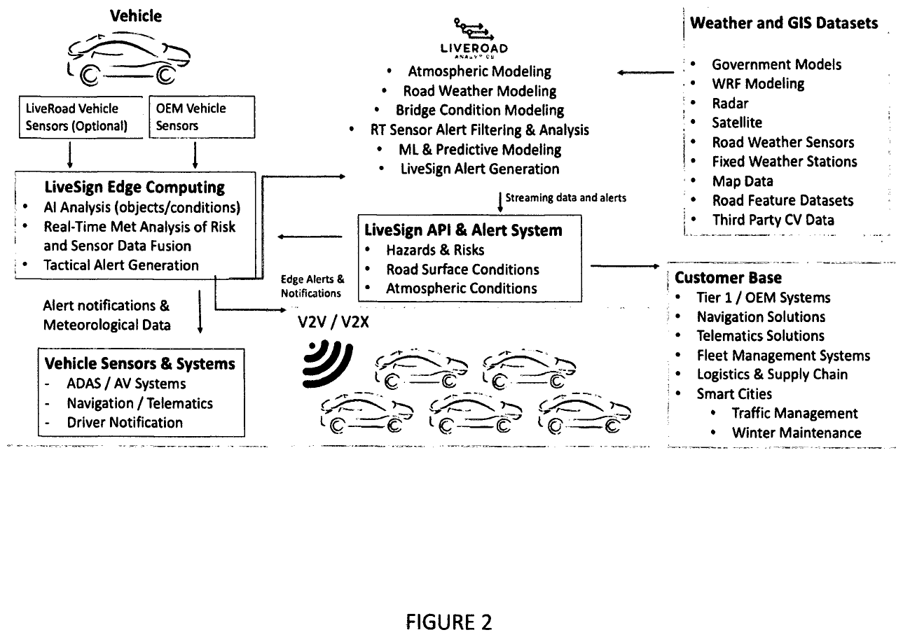

FIG. 2 illustrates an example of a weather modeling system. This system uses a comprehensive combination of weather forecasting and weather reporting systems to create a real-time weather model, taking the best available information from multiple sources. Not only does the system capture actual weather conditions as reported, for instance, by vehicles traveling along roads throughout the world, but also weather forecasts generated from known and reliable forecasting centers. Then, through a combination of artificial intelligence and knowledge bases containing prior weather reports for road segments (and corresponding prior weather forecasts for such road segments) detailed and reliable road condition forecasts can be generated. In operation, the system can transmit information based on either actual recent weather condition reports, or reliable predictions based on previous observations and reports, along with current forecasts. The decision as to whether to forward predicted weather conditions, or recently observed weather conditions can be further managed by a remote expert system. Such a system would desirably include a weighting approach such that a recent weather observation is given more likelihood of being accurate than an older report. Also, the system could give more weight to a report of a dangerous condition than to a report of safe conditions. For example, if there was an observation recently that snow is on the road, but a more recent predictive assessment indicates a low likelihood of snow, the system can rely on the safer approach and report that it appears that there is snow on the road. Another feature that might be advantageous relies on a voting algorithm. If some recent vehicles observed icing on the road and others did not, a safe assumption would be made, reporting that there appears to be icing on the road. However, if all recent vehicles failed to report icing, but a predictive algorithm suggested a chance of icing, the system could reasonably conclude that there is no icing.

As a further example, it is difficult to predict fog, but it is possible to send information to the vehicle that there is some given numerical percentage chance of fog. Then the vehicle systems can, using, for example, edge computing with inputs from systems such as a vehicle slowing, wipers going on, fog lights turning on, and also potentially using data from camera and or LIDAR, depending on what is available. That determination that there is in fact fog, given that particular percentage chance of fog, can be sent back to the platform. The data in the API feed would then indicate that there is actual fog, not just a chance thereof. The data will also then include the incidence of fog given that location and set of measured conditions.

As used herein, the term average is used to indicate any fashion of generally, as opposed to specifically and individually, accumulating information from a number of different vehicles and then providing an output indicative of the roadway conditions. A primary focus of the sensing of roadway conditions is mentioned as being early identification of locations where driving might pose higher than average risks—particularly from conditions related to weather, whether it be snow, icing, or rain. Slippery conditions are a major focus area. Slippery conditions are addressed differently in the previously mentioned patents, referring either to accident rates, coefficient of friction or slip rates. Each of these, and other equivalents all fall ultimately within the general umbrella of traction value for the vehicle. The terms traction, friction, slip, maximum acceleration, deceleration, turning rate, etc. all relate generally to friction, and they all are important to the implementation of certain aspects of the invention.

Based on the traction value indicated by the safety systems of the prior art, signals are provided to the particular vehicle to aid in staying safe. When information is provided to the particular vehicle, it is then possible to determine a suitable defensive safe driving speed.

A preferred approach of implementing this aspect of the present invention starts from that previously disclosed system—a system that provides to all vehicles traveling a particular roadway segment an indication of a roadway condition. Transmission of this information may be via a satellite system or via locally positioned transmission towers 300 (illustrated in FIG. 1) and in either case relies on a vehicle mounted antenna 101. This implementation of the present invention introduces a supplemental level of information that can more particularly assist in safe operation of a specific, target or subject vehicle. This supplemental information characterizes the deviation in roadway performance of the particular vehicle from the generalized roadway performance of a collection of other vehicles, the baseline vehicle. Thus, when a particular, subject vehicle tends to have better traction than other vehicles, a determination can be made that the roadway can be navigated at a somewhat higher speed than other typical vehicles, as referred to collectively as a baseline vehicle. Importantly, when a particular vehicle has poorer traction than the average of other vehicles, the system can apply the previously calculated deviation adjustment to the driving parameters to keep the vehicle safe. Thus, the vehicle implementing the invention might drive either slower or faster than indicated safe by a centralized safety system, depending on the individual characteristics of the specific vehicle.

To provide the predetermined deviation information that is employed in this embodiment of the invention, the specific vehicle can be operated through multiple roadway segments and the traction capabilities for the vehicle can be sensed and recorded. A number of other vehicles can also be operated through the same roadway segments and the traction capabilities of those vehicles can also be sensed and recorded. The number of other vehicles should be at least 5 to provide sufficient information for determination of the typical range of operating parameters. Having more than 25 other vehicles is believed sufficient to form a highly reliable indication of average traction values. Of course an important consideration is to gather an appropriate amount of information to make an informed decision as to the driving approach that is safe. Thus, it might be entirely reliable to base a decision on information that was received within the past few seconds from a single leading vehicle. Perhaps it would be reliable to base decisions on a single leading vehicle if the report of conditions is less than a minute old. As the lead time of the prior condition report increases, reliability decreases. Thus, it might be suitable to rely on several prior reports according to a threshold approach, for instance for each elapsed minute, it is required to have at least one incremental prior condition report. Thus, if the most recent report was three minutes prior, there must be two additional reports of road conditions within the next earlier minute. Otherwise, it could be concluded that the information is not sufficiently current to meet the safety requirements. Then, once the actual condition reports are not current enough for a reliable indication, the system can return to relying on predicted road conditions.

There are additional considerations related to determining whether the prior local information is reliable enough for making safety decisions. Another way of considering this prior information involves establishing a priority system pursuant to which available information is evaluated for application to operation of the system. It can be determined from recent passes of other vehicles whether locally collected roadway information is reliable. There can be a threshold based on the number of data points and their proximity as to time and location. In a desirable implementation it might be required to consider at least 5 outside reports within the prior 5 minutes and to call for at least 10 reports within the past 10 minutes before these outside reports are used as a basis for decision making within the system. Further, if there was snow or ice within the past hour, consider that it is still there in spite of more recent reports. However, if the road was dry and clear for the past hour, but a recent report shows a wet road, conclude that the road is wet—make safety decisions based on the level of danger. The greater the danger, the longer the assumption survives that the risk is still there.

The roadway segments employed for characterizing the vehicle performance of the subject vehicle can be a special purpose track where all conditions are closely monitored and all vehicles traveling the track are meticulously regulated as to speed and driver control maneuvers so that comparative information is very reliable. With this arrangement sample road conditions are created for reliable setup of baseline vehicle information. Each vehicle can make multiple passes through the track under varying weather conditions. This will allow a comprehensive characterization of the traction performance of each vehicle, thereby allowing an average to be conveniently calculated. Information as to the maximum acceleration, maximum deceleration, maximum turn radius and other vehicle performance metrics can be gathered. Turn radius is used herein to refer generally to the sharpness of the return rather than to some literal radius. Similarly, surface smoothness means any indication of the presence of irregularities in the surface such as coarse pavement, grooved pavement, potholes, etc. that will impact the tires' tendency to slip. However, that dedicated vehicle characterizing approach may be inconvenient. Thus, it is anticipated that the comparative information will be generated through actual on the road driving conditions where multiple vehicles driving on a roadway segment have sensor systems suitable for collecting traction information sufficient for creation of an average traction indication. This has the advantage of having real-time traction information for the subject vehicle. Having this real-time information is valuable because vehicle operating conditions change from time to time due to vehicle changes such as tire wear, vehicle loading and other factors such as wheel alignment. Thus, by using the most recent information generated while on the present trip, it is less likely that any significant vehicle conditions have changed. Perhaps the filling of fuel tanks or a relocation of a person or luggage within the vehicle could introduce some anomaly, but this will quickly be eliminated as new real-time samples are added to the on-board vehicle deviation figures stored in on-board safety unit 102.

In a general manner, a preferred manner of implementing the invention involves the creation of a centralized databank through the use of detectors carried by a plurality of vehicles to characterize the conditions existing along a roadway, including conditions such as variations along the roadway in surface conditions. These conditions might include surface texture, surface wetness, icy, dewy and snowy conditions, tendencies to differ in temperature from other roadway segments, roadway slope and even temporary conditions such as potholes or other surface imperfections. This information collectively is referred to as road conditions, while a subset of this information is road characteristics, and another subset is environmental factors. With this information available, and with a database of current (detected or predicted) atmospheric conditions, a predicted roadway condition can be created and transmitted to vehicles travelling along the roadway. Providing this information with respect to particular roadway locations is effectively mapping the roadway information. Mapping of data as mentioned herein broadly means recording data in a manner such that it is associated with a roadway location, not necessarily in the form of a route map. Then, with an on-board processing capability for determining the specific vehicle's deviation from average performance, starting with a previously determined deviation, and then updating the deviation as the vehicle is driven, with real-time information right up to the minute, safer vehicle operation is enabled.

Further, in order to keep the central system operating based on the best available information, the specific vehicle can be equipped with optical, infrared and acoustic sensors 103 to monitor the road surface as the vehicle travels the roadway. The acoustic sensors can detect the sound of the tires during driving and detect changes in sound that might correspond to changes to any of roadway smoothness, wetness, icing snow or surface imperfections. Then, the results of the acoustic detection can be sent back to the central system noting the changes in sound. The locations of these changes can be compared to previous records to determine whether everything is as expected, or whether the roadway is not exactly as had been expected. These deviations can be employed to alter the central information being provided to other travelling vehicles.

If desired, sensors can also be employed to detect the temperature of the pavement, and again the central system can alter its reported information when the vehicle sensors detect surface temperatures different from what had been expected. This might occur for instance when there is a local cloud allowing localized roadway cooling relative to nearby roadway surfaces. Use of optics to monitor road surface to detect surface conditions is also possible and the output from optical sensors can be employed to report rough and/or wet conditions. Similarly, optical sensors might be employed to detect smoke and fog, again for purposes of allowing the central system to recommend slower driving speeds.

In an effort to maximize the effectiveness of vehicle safety, reliance on the internet-of-things, big data analytics and sophisticated meteorological technology. In a preferred implementation, this technology provides a statistically based road temperature and road condition model. It can be globally scaled and can use machine-learning on large numbers of observations from widely varying sources (RWIS, ASOS/AWOS, etc.) and can fine-tune the output to take into consideration multiple numerical weather prediction models in order to secure information related to the expected weather on every section of road in the world.

While averages are mentioned herein as though some middle of the road number is contemplated, it may be that the “average” to be indicated is actually offset from a mathematical average to provide a safer operating level. Thus, the indicated composite indication might report on the 90^{th} percentile (that is, 90% of vehicles will be safe at the indicated operating level) to be sure that almost all vehicles will be safe if they follow the driving guidance. Similarly, the indication might be based on the absolute worst performer among all tested vehicles. Again, safety systems strive to protect everyone and thus a safety system design directed to a worst performer is a definite possibility. While traveling along a particular roadway, real time deviation information in the indicated operating conditions will automatically adjust for safety system design features such as use of a worst performer instead of an average performer. What is desired is that the on-board deviation calculation reflects the actual deviation between the indicated performance of the averages, the baseline vehicle, and the subject vehicle's actual performance. This then can be extrapolated to the remainder of the projected route.

The terms ‘operating conditions’ and ‘vehicle performance’ are also used to indicate any roadway or vehicle parameter that is either monitored or controlled during practice of the invention. Thus, when it is stated that the vehicle is controlled as a function of some indication received from a central system, this might be fully autonomous, or might be fully implemented by a vehicle driver in response to a warning indicator. The key thing in this aspect of the invention is that information received from the central system can be customized to reflect the specific performance of the driven vehicle rather than only relying on the indicated or predicted performance (individual performance or combined performance) of other vehicles.

In another mode of practicing the invention, a condition other than vehicle traction might be addressed. For instance, on-board sensors might detect a tendency for icing, or for detecting limited visibility arising from fog. The advanced computing approach described with respect to assessing the safe driving speed as a function of a particular vehicle's deviation from average vehicle performance can also be utilized to determine whether a vehicle will experience windshield icing. A plurality of vehicles can be evaluated for actual icing as a function of atmospheric conditions and information can be averaged for purposes of generating a generalized safety message. However, any particular vehicle might respond differently, perhaps due to a better or worse defrosting system, the angle of the windshield relative to the direction of vehicle travel, or other vehicle-specific condition that influences windshield icing. Assessing the individual vehicle performance relative to averages can allow the individual vehicle to respond in its own unique (or at least vehicle-specific) manner upon receipt of potential icing condition signals from a central information source. This individualized determination can allow efficient and safe vehicle responses to the expected icing conditions, such as increasing defroster temperatures or airflow, turning on windshield wipers or adjusting vehicle speed.

In yet another mode of employing the invention, it is possible to provide feedback to a central safety system, such as the LiveRoad System, to supplement the data available for establishing the averaged condition reports that are provided to all vehicles travelling the roadway segment. The feedback to the central system can include not only the detected conditions, such as rain, icing, fog, snow or even slow moving traffic, but it an also include a report of the specific-vehicle deviation from averages for the purpose of providing an additional level of detail to the central databank. Knowing that a particular vehicle has been accurate in providing its deviation from average can aid in confirming that the average information being provided is reliable for vehicles navigating the roadway.

Another implementation of the invention might involve a method of improving the safe operation of a target vehicle along a stretch of road according to a process involving creating a roadway database associated with the specific stretch of road where the database contains information indicating the maximum safe operating speeds at certain locations along the stretch of road for a baseline vehicle as a function of road conditions. The road conditions are a composite of the underlying baseline road characteristics and the environmental factors that alter vehicle-to-road interaction. The database can store information related to a large number of points along the roadway and is preferably more thorough in and around road sections that have risky conditions such as dips and turns. The baseline road conditions are made up on information that reflects the road under optimum driving conditions, such as clean and dry. Baseline information includes details about conditions such as surface texture, rough pavement, potholes and pavement grooves. Also, factors such as sloped pavement, particularly sloped towards a side of the road is included in baseline information. Another aspect of baseline information is turns, characterized perhaps by the turn radius or perhaps by a maximum safe speed for traversing the turn, the important consideration being information indicating a risk factor. These features of the roadway are recorded in association with location information, effectively mapping the location of the data points along the roadway. Additionally included in the mapping could be factors such as surface wetness, ice, snow or road debris, in each case something incremental to the baseline road conditions. In this embodiment, determining road conditions is based on baseline road characteristics as well as on environmental factors at said plurality of locations. The collection of environmental information involves collecting road condition information from a plurality of individual vehicles that have driven along the roadway of interest, specifically past the individual points that being mapped. Sensor information from braking, traction control and any other sensors such as air temperature, road surface temperature, road surface coatings such as water, frost, ice, or snow and even debris such as dirt or sand can be recorded as pertinent to safe operating speeds at each location along the roadway. The collective assessment of the presence of any of water, frost, ice and snow is referred to as assessment of the water status of the pavement.

Next comes the creating of a database recording the performance characteristics of a baseline vehicle including characteristics such as maximum acceleration, maximum deceleration, and maximum turning capability, in each case under a representative sampling of possible road conditions. With this information it is possible to determine the safe operating speed of the baseline vehicle at substantially any road location and under a wide array of possible road conditions. The maximum acceleration, deceleration and turning capability typically refers to the point at which traction is lost. However, a safety factor could be introduced, for instance 90% of the respective parameter being assessed. Thus, the braking, accelerating and turning limits reported for each vehicle tested for building up the needed information relative to a baseline vehicle will have a built in safety factor.

Further implementation of this embodiment of the invention involves creating a second database on board the target vehicle indicating deviations in the performance characteristics of the target vehicle relative to the performance characteristics of the baseline vehicle. This is a function of road conditions and performance parameters of the target vehicle, The next step involves creating a database of performance parameters of the target vehicle at a plurality of road conditions based, for instance, on maximum vehicle acceleration, maximum vehicle deceleration and maximum turning capability, With this information for the target vehicle and having similar information related to the baseline vehicle, it is possible to determine the target vehicle's performance deviation from the baseline vehicle performance. Finally, determining the safe operating speed of target vehicle at any mapped roadway locations can be calculated or otherwise derived based on safe operating speed data from said first database and performance deviation information from the second database.

While the present invention has been described with respect to several implementations, it is to be understood that these are exemplary only and are not intended to mean that these are the only manners of implementing the invention. As will be apparent to those skilled in the art, many variations of the examples will be possible without deviating from the underlying invention.

1. A method of improving the safe operation of a first vehicle along a stretch of road comprising:
a. creating a first database associated with said stretch of road indicating safe operating speeds at a plurality of locations along said stretch for a baseline vehicle as a function of road conditions,
i. determining road conditions based on baseline road characteristics and environmental factors at said plurality of locations,
1. creating a map of baseline road conditions at said plurality of locations including at least one of road slope, turn radius and surface smoothness,
2. creating a map of environmental factors at said plurality of locations, said environmental factors including at least one of road temperature, road wetness, and the presence of any of frost, ice and snow,
ii. creating a database of the performance characteristics of said baseline vehicle at a plurality of sample road conditions, said performance characteristics including at least one of maximum acceleration, maximum deceleration, and maximum turning capability,
iii. determining the safe operating speed of said baseline vehicle at each of said locations under said plurality of sample road conditions,
b. creating a second database on board said first vehicle indicating deviations in the performance characteristics of said first vehicle relative to said baseline vehicle as a function of road conditions and performance parameters of said first vehicle,
i. creating a database of performance parameters of said first vehicle at a plurality of road conditions based on at least one of maximum vehicle acceleration, maximum vehicle deceleration and maximum turning capability,
c. determining the safe operating speed of said first vehicle at said locations based on safe operating speed data from said first database and performance deviation information from said second database.

2. A method as claimed in claim 1 wherein creating a database of the performance characteristics of said baseline vehicle at a plurality of sample road conditions includes data from at least five individual vehicles each driven through a test road course at a plurality of predetermined speeds and sampling the degree of vehicle slippage at each predetermined speed, and further includes determining an average slippage value from said individual vehicles.

3. A method as claimed in claim 1 wherein determining road conditions based on baseline road characteristics and environmental factors at said plurality of locations comprises collecting road condition information from a plurality of individual vehicles that have driven past said plurality of locations, said information including road surface water status.

4. A method as claimed in claim 3 wherein creating a map of environmental factors at said plurality of locations, said environmental factors including at least one of air temperature, road temperature, road wetness, and the presence of any of frost, ice and snow, includes:
receiving a weather forecast including forecast environmental factors for said locations and using the forecast environmental factors to determine the environmental factors.

5. A method as claimed in claim 4 wherein said forecast environmental factors are compared to a historical weather database and wherein said map of environmental factors includes location-specific modified forecast environmental factors.

6. A method as claimed in claim 5, further including:
providing data sensed by said first vehicle to said first database, including an indication of the deviations in the performance characteristics of said first vehicle from said baseline vehicle.

7. A method as claimed in claim 5, further including providing data related to environmental factors.

8. A method as claimed in claim 7 wherein said data related to environmental factors are sensed by an acoustic sensor that receives tire noise while said first vehicle is in motion.

9. A method as claimed in claim 1 wherein said first database includes environmental factors generated as a function of predicted weather, road surface data sensed at said plurality of locations and weather sensed at said plurality of locations.

10. A method as claimed in claim 9 wherein said environmental factors are generated according to a priority analysis of predicted weather and sensed road surface conditions.

11. A method of improving the safety of a subject vehicle comprising the steps of:
determine a vehicle performance characteristic from a plurality of vehicles as a function of actual weather at a plurality of locations,
determine a vehicle performance characteristic of said subject vehicle as a function of actual weather at said plurality of locations and as a function of substantially the same weather,
determine deviation of the subject vehicle from the average of the others for each of a plurality of different vehicle performance characteristics, predict weather at a location on a planned route,
determine a vehicle performance characteristic of vehicles recently at said location on said planned route,
predict the subject vehicle's performance as a function of the performance characteristic of vehicles recently at said location and the predicted weather and the previously determined deviation.

12. The method of claim 11 including the steps of:
determine deviation of driven vehicle's coefficient of friction from average coefficient of friction from said plurality of other vehicles as a function of weather,
predict the driven vehicle's coefficient of friction as a function of predicted weather and said deviation,
a. where determination of deviation occurs while driving a user selected route,
b. where positions on the route have associated averages from prior drivers,
where a coefficient of friction map has average coefficient of friction curves based on weather,
c. create a predicted road condition based on weather forecast to assess expected changes.
